(19) United States
(12) Patent Application Publication
(10) Pub. No.: US 2013/0246299 A1
(43) Pub. Date: Sep. 19, 2013

(54) BUSINESS COMMUNICATION SYSTEM AND METHOD

(71) Applicants: Kenneth J. Lovegreen, Lake Kiowa, TX (US); Sandra Stanko, Commerce City, CO (US)

(72) Inventors: Kenneth J. Lovegreen, Lake Kiowa, TX (US); Sandra Stanko, Commerce City, CO (US)

(21) Appl. No.: 13/776,125

(22) Filed: Feb. 25, 2013

Related U.S. Application Data
(63) Continuation-in-part of application No. 12/931,819, filed on Feb. 11, 2011.

(51) Int. Cl. G06Q 30/02

(52) U.S. Cl. CPC G06Q 30/0281
USPC 705/346

(57) ABSTRACT

A system and method for enabling a customer to utilize a smart phone to communicate with a waiter in a restaurant. The phone connects to a wireless LAN within the restaurant and, in a first embodiment, downloads a location-based communication application, which reports the phone's location to a Website Application Server (AS), which identifies the restaurant. The customer enters a table number, and the Website AS pushes a screen to the phone displaying buttons for requesting services. When the customer presses a button, the Website AS informs the LAN controller, which identifies an assigned waiter and routes the service request to the waiter. In another embodiment, the phone connects to the LAN and the customer enters a web page address. An Access Point routes the request to the LAN controller, which pushes the display screen to the phone, handles service requests, and notifies the assigned waiter.

### RELATED APPLICATIONS

This application is a Continuation-in-Part of U.S. patent application Ser. No. 12/931,819 filed Feb. 1, 2011.

### BACKGROUND

1. Technical Field

This invention relates to communication systems and, more particularly, to a wireless communication system and method enabling a customer in a restaurant or other business establishment to utilize a person smart phone or other mobile telecomputing device to communicate with a waiter or other service person.

2. Description of Related Art

In some restaurants today, customers can push a button on a transmitter mounted on their table to request service from their waiter. The transmitter may be programmed to transmit a table number to a control PC, or to transmit an identifier that is then associated with a table number by the PC. The PC may also include a list of waiters assigned to each table number and a lookup table for identifying corresponding pager numbers for the waiters. An on-premises paging transmitter then pages the correct waiter to respond to the customer's request for service.

U.S. Patent Application Publication No. 2002/0147647 describes a system in which a local patron utilizes a touch screen terminal mounted at the patron's table. This terminal belongs to the restaurant and is not mobile. The patron can use the terminal to communicate through a maitre d' system with a waiter carrying a communication device. A remote user can use a two-way interactive device such as a pager or web-enabled cell phone to dial into the maitre d' system to place orders. However, the remote user does not bring the device to the restaurant and cannot use it to communicate with a waiter.

### SUMMARY OF THE INVENTION

Mounted transmitters have the additional disadvantage that the restaurant staff must maintain and, if necessary, repair them. Batteries must be regularly replaced, and the transmitters are susceptible to damage by customers.

It would be advantageous, therefore, to have a restaurant communication system and method enabling a customer to communicate with a waiter while eliminating the need for the restaurant staff to maintain or repair transmitters mounted on the tables. The present invention provides such a system and method.

In one embodiment, the present invention is directed to a method of enabling a customer to utilize a personal mobile telecomputing device to communicate with a waiter in a restaurant. The method includes the steps of establishing by a local area network (LAN) controller, a wireless connection between the customer's mobile telecomputing device and a wireless LAN within the restaurant; and downloading to the customer's mobile telecomputing device by the LAN controller, a location-based communication application. The application reports location information of the customer's mobile telecomputing device to a Website Application Server (AS); and the Website AS identifies the restaurant where the customer is located based on the reported location information. The method also includes receiving by the Website AS, a table number where the customer is seated in the identified restaurant; pushing from the Website AS to the customer's mobile telecomputing device, a screen displaying buttons for requesting services in the restaurant; and receiving by the Website AS, an indication that the customer pressed one of the buttons associated with a service request. The method also includes communicating to the LAN controller within the restaurant, the service request and the table number where the customer is seated; matching the table number to an assigned waiter by the LAN controller; and routing the service request and table number by the LAN controller to a communication device accessible by the assigned waiter.

In another embodiment, the present invention is directed to a system for enabling a customer to utilize a personal mobile telecomputing device to communicate with a waiter in a restaurant. The system includes at least one processor for controlling operation of the system; a Website AS; and a wireless LAN within the restaurant for communicating with the customer's mobile telecomputing device, the LAN including a LAN controller configured to download to the customer's mobile telecomputing device, a location-based communication application, which causes the customer's mobile telecomputing device to report location information of the customer's mobile telecomputing device to the Website AS. The Website AS is configured to identify the restaurant where the customer is located based on the reported location information; receive a table number where the customer is seated in the identified restaurant; push to the customer's mobile telecomputing device, a screen displaying buttons for requesting services in the restaurant; receive an indication that the customer pressed one of the buttons associated with a service request; and communicate to the LAN controller within the restaurant, the service request and the table number where the customer is seated. The LAN controller is further configured to match the table number to an assigned waiter; and route the service request and table number to a communication device accessible by the assigned waiter.

In another embodiment, the present invention is directed to a method of enabling a customer to utilize a personal mobile telecomputing device to communicate with a waiter in a restaurant. The method includes the steps of connecting the customers mobile telecomputing device to a wireless LAN controlled by a LAN controller within the restaurant; receiving by an Access Point for the LAN from the customers mobile computing device, a request to navigate to a web page address; and routing the request by the Access Point to a local web page hosted by the LAN controller. The method also includes obtaining by the LAN controller from the customer's mobile telecomputing device, a table number where the customer is seated in the restaurant; pushing by the LAN controller to the customers mobile telecomputing device, a screen displaying buttons for requesting services in the restaurant; and receiving by the LAN controller, an indication that the customer pressed one of the buttons associated with a service request. The method also includes determining by the LAN controller, an assigned waiter for the customer; and routing the service request and table number by the LAN controller to a communication device accessible by the assigned waiter.

In another embodiment, the present invention is directed to a system for enabling a customer to utilize a personal mobile telecomputing device to communicate with a waiter in a restaurant. The system includes at least one processor for controlling operation of the system; and a wireless LAN within the restaurant for communicating with the mobile telecomputing device, the LAN including an Access Point and a LAN controller. The Access Point is configured to receive from the customer's mobile computing device, a request to navigate to a web page address; and to route the request to a local web page hosted by the LAN controller. The LAN controller is configured to obtain from the customers mobile telecomputing device, a table number where the customer is seated in the restaurant; push to the customer's mobile telecomputing device, a screen displaying buttons for requesting services in the restaurant; receive an indication that the customer pressed one of the buttons associated with a service request; determine an assigned waiter for the customer; and route the service request and table number to a communication device accessible by the assigned waiter.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram of a first exemplary embodiment of the system of the present invention;

FIG. 2 is a flow chart illustrating the steps of a first exemplary embodiment of the method, of the present invention;

FIG. 3 is a simplified block diagram of a second exemplary embodiment of the system of the present invention;

FIG. 4 is a flow chart illustrating the steps of a second exemplary embodiment of the method of the present invention;

FIG. 5 is a simplified block diagram of a third and a fourth exemplary embodiment of the system of the present invention;

FIG. 6 is a flow chart illustrating the steps of the third exemplary embodiment of the method of the present invention;

FIG. 7 is a flow chart illustrating the steps of the fourth exemplary embodiment of the method of the present invention;

FIG. 8 is a simplified block diagram of a fifth and a sixth exemplary embodiment of the system of the present invention;

FIGS. 9A-9B are portions of a flow chart illustrating the steps of the fifth exemplary embodiment of the method of the present invention; and

FIG. 10 is a flow chart illustrating the steps of the sixth exemplary embodiment of the method of the present invention.

### DETAILED DESCRIPTION OF EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components, and circuits have not been described in detail so as not to obscure the present invention. The invention may be implemented in hardware or in a combination of hardware and software. For example, one or more computers or processors may perform the steps of the method of the present invention when executing computer program instructions stored in one or more program memories. Additionally, individual components of the invention may include their own processor and memory for controlling their functions.

The present invention provides a solution in which the customer's mobile phone is used as a restaurant communication device. Large numbers of customers now carry personal computing devices such as Personal Digital Assistants (PDAs) or “smart phones”, which are highly capable processing and communication devices. Smart phones can access both the cellular telephone network referred to as the Public Land Mobile Network (PLMN) through radio base stations as well as Local Area Networks (LANs) through unlicensed radio access networks utilizing WiFi or Wireless LAN (WLAN) technology. In addition to voice calls, smart phones can send text messages, e-mails, and can access the Internet and worldwide web.

The invention is described herein in terms of a customers smart phone although the invention is applicable to any type of mobile computing device capable of making a WiFi connection and communicating through the WiFi connection. These devices may be referred to generically as mobile telecomputing devices. The present invention takes advantage of these capabilities of mobile telecomputing devices.

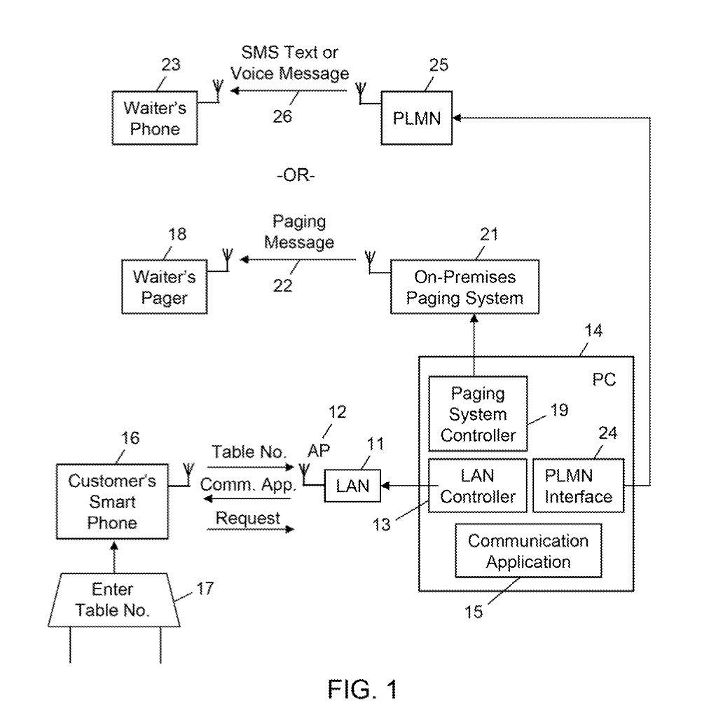

FIG. 1 is a simplified block diagram of a first exemplary embodiment of the system of the present invention. In this embodiment, a WiFi Local Area Network (LAN) 11 is set up with at least one Access Point/WiFi router (AP/router) 12 inside the restaurant. The network may be controlled, for example, by a LAN controller 13 in a PC 14 in a back office of the restaurant. The customer is provided with a table number and instructions for downloading a restaurant communication application 15 to the customer's smart phone 16. This information may be provided by a sign at each table or may be provided to the customer by a hostess or the waiter. The customer follows the instructions and connects to the WiFi network and downloads the application to the customers smart phone.

The application gathers data from the back office PC to define the functions of various buttons displayed to the customer on the phone's touch-screen display, or present on the phone's keyboard. When prompted by the application, the customer enters the table number 17. The customer can then use the smart phone to communicate with the waiter as further described below.

In an example scenario, a first button may be used to request a drink; another button may be used to request the customers check; and another button may enable the customer to enter a text message with specific instructions for the waiter. When the customer presses one of the defined buttons, the communication application on the customer's phone sends a corresponding indication and the table number over the WiFi network 11 to the back office PC 14, which also controls communications with the waiter. In one embodiment, the waiter carries an on-premises pager 18, and a paging system controller 19 in the back office PC controls an on-premises paging system 21. The PC matches the table number with the waiter who is responsible for that table, and sends a command to the on-premises paging transmitter to send a paging message 22 to the waiter with the customer's table number and request. In an alternative embodiment, if the restaurant does not have an on-premises paging system, the waiter may carry a mobile phone 23 instead. In this embodiment, the back office PC includes a PLMN interface 24, which may place a call to the waiter's phone through the PLMN 25 with a recorded voice message or a Short Message Service (SMS) text message 26 indicating the table number and the customer's request. The waiter then responds to the customer's request.

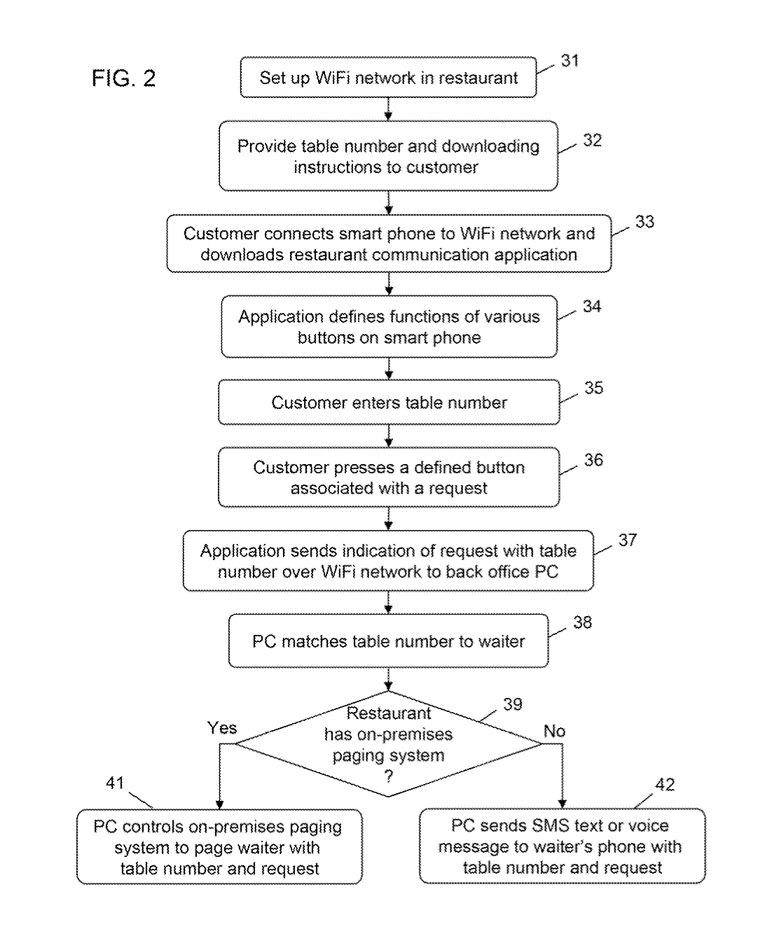

FIG. 2 is a flow chart illustrating the steps of a first exemplary embodiment of the method of the present invention. At step 31, the WiFi network 11 is set up in the restaurant. At step 32, the table number and application-downloading instructions are provided to the customer. At step 33, the customer connects the smart phone 16 to the WiFi network and downloads the restaurant communication application 15. At step 34, the communication application defines the functions of various buttons on the smart phone. At step 35, the customer enters the table number.

At a later time indicated in step 36, the customer presses a defined button on the smart phone 16 associated with a request. At step 37, the communication application downloaded to the phone sends an indication of the request with the table number over the WiFi network to the back office PC 14. At step 38, the PC matches the table number to the waiter. At step 39, it is determined whether the restaurant has an on-premises paging system. If so, the method moves to step 41 where the PC controls the on-premises paging system to page the waiter with the table number and request. If the restaurant does not have an on-premises paging system, the method moves to step 42 where the PC sends either an SMS text message or a recorded voice message to the waiter with the table number and request.

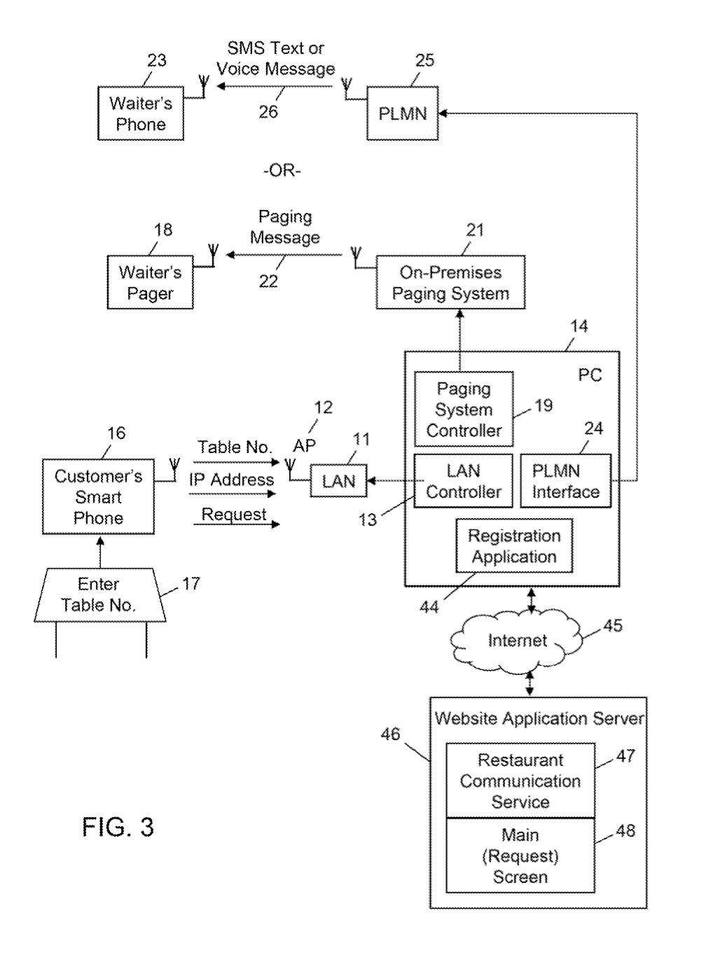

FIG. 3 is a simplified block diagram of a second exemplary embodiment of the system of the present invention. In this embodiment, the customer's smart phone 16 is registered (for example by registering the smart phone's IP address) with a registration application 44 running on the back office control PC 14. This may be done when the customer is seated and logs onto the WiFi network 11. Likewise, the customer's phone is deregistered when the customer leaves the restaurant or the signal is otherwise lost or falls below a threshold signal strength level. When the customer accesses the WiFi network, the registration application directs the smart phone 16 over the Internet 45 to a website with an application server 46 providing a restaurant communication service 47. The customer can click on “Normal view” or “Mobile View” but cannot surf through this website; it is dedicated to providing service buttons only. The website may request the customer's table number, or the number may be obtained and provided to the website by the back office application. If provided by the customer, the website may display, for example, a message such as, “Please enter your table number found on the sign on your table.” The customer enters the table number and is then directed to another webpage (Main Screen) 48 that may simply display a number of request buttons with labels such as Check, Drink Refill, Service, Ketchup, and the like. Definitions of the buttons are configurable by the restaurant management.

When the customer presses a button, the screen may momentarily display a message such as, “Your request is being processed”. The screen then returns to the Main Screen of buttons. The website application server 46 sends the customer selection and table number to the back office PC 14, which delivers the message to the appropriate waiter as described above using either the on-premises paging system 22 or the PLMN 25. The waiter then responds to the customer's request.

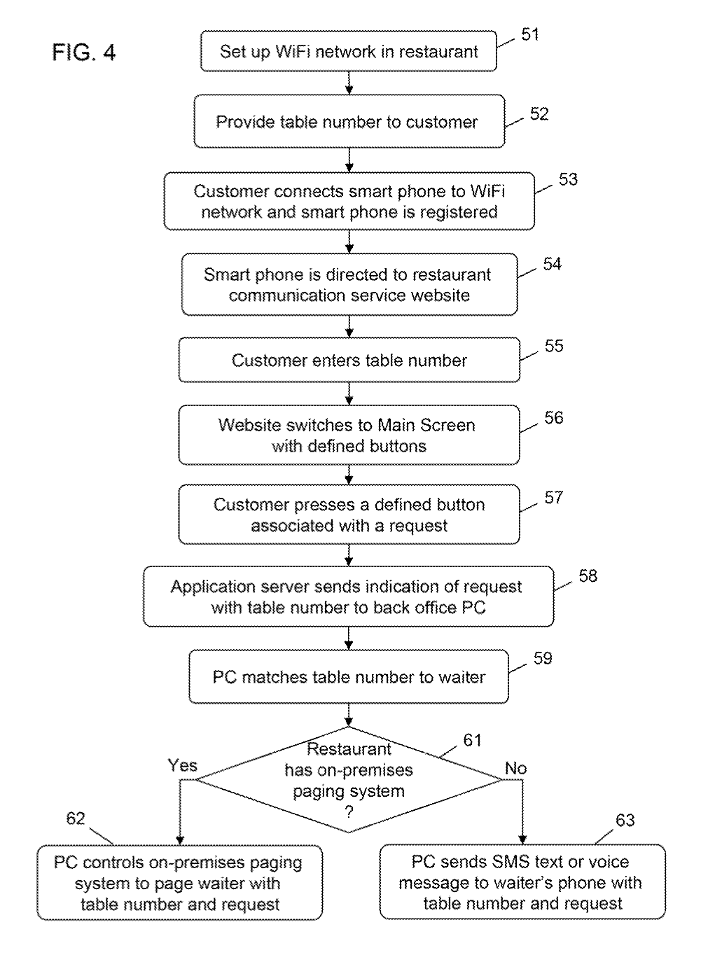

FIG. 4 is a flow chart illustrating the steps of a second exemplary embodiment of the method of the present invention. At step 51, the WiFi network 11 is set up in the restaurant. At step 52, the table number is provided to the customer. At step 53, the customer connects the smart phone 16 to the WiFi network and the registration application 44 registers the smart phone. At step 54, the registration application directs the phone to the restaurant communication website 46. At step 55, the customer enters the table number.

At step 56, the website switches to the Main Screen of defined request buttons, which appear on the touch screen display of the smart phone 16. At a later time indicated in step 57, the customer presses a defined button on the smart phone associated with a request. At step 58, the application server sends an indication of the request with the table number to the back office PC 14. At step 59, the PC matches the table number to the waiter. At step 61, it is determined whether the restaurant has an on-premises paging system. If so, the method moves to step 62 where the PC controls the on-premises paging system to page the waiter with the table number and request. If the restaurant does not have an on-premises paging system, the method moves to step 63 where the PC sends either an SMS text message or a recorded voice message to the waiter with the table number and request.

An advantage of the second embodiment is that it is more resistant to spoofing by former customers or other individuals who log onto the WiFi network from outside the restaurant in order to send bogus messages to waiters inside. The registration application only allows on-premises access to the restaurant communication website and blocks outside access attempts. The registration application may decode any requests destined for the website and grant access to the website only if the calling phone is currently registered with the application. If so, the application determines which waiter is responsible for that table and pages the appropriate waiter.

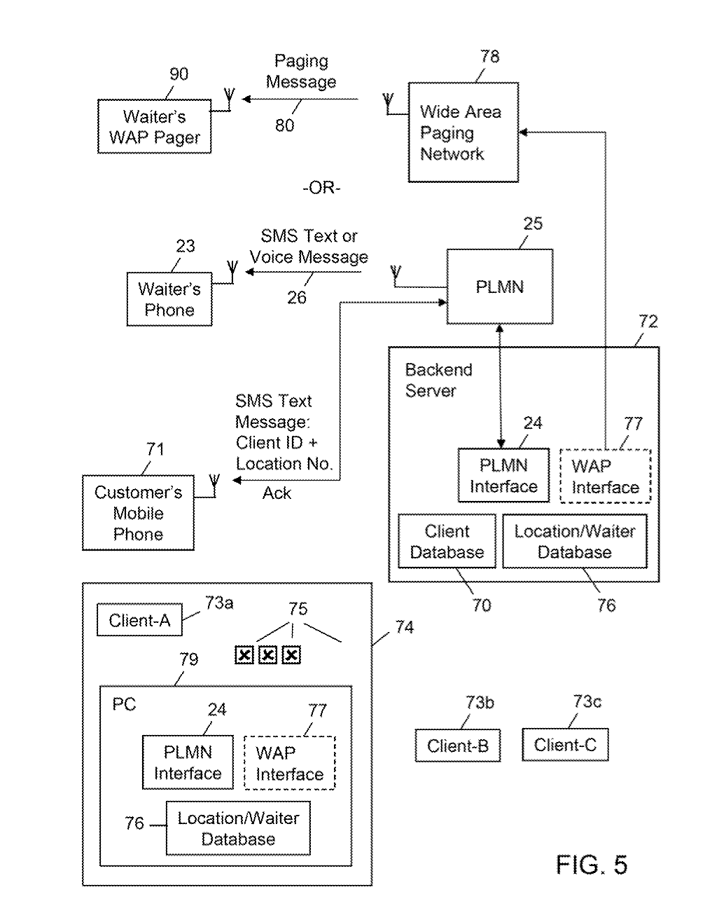

FIG. 5 is a simplified block diagram of a third and a fourth exemplary embodiment of the system of the present invention. This embodiment addresses the scenario in which there is no WiFi network available to the customer, but the customer has access to the PLMN 25 using a mobile communication device such as a cellular phone 71. In this embodiment, a backend server 72 may service a number of different clients 73a-73c which may be, for example, different companies, hotels, restaurants, or the like. Each client, such as client 73a, may have a domain of responsibility 74 where the client's customers are located. A number of locations 75 within the domain of responsibility are assigned identification numbers, and a service person is assigned to serve customers at various locations. The backend server maintains a location/waiter database 76 of location numbers and associated service persons such as waiters. In the case of a restaurant, the domain of responsibility may be the dining room, the locations may be dining tables, and the service persons may be waiters serving customers in the dining room. For a hotel, the domain of responsibility may include an area on the hotel beach, the locations may be beach umbrellas or beach chairs, and the service persons may be waiters assigned to serve food and/or beverages in locations other than the hotel restaurant. The backend server 72 also includes a PLMN interface 24 and optionally a wide area paging (WAP) network interface 77 for communicating over a wide area paging network 78. In an alternative embodiment described below, a PC 79 implemented at each of the client's location includes the database 76, the PLMN interface 24, and optionally the wide area paging network interface 77.

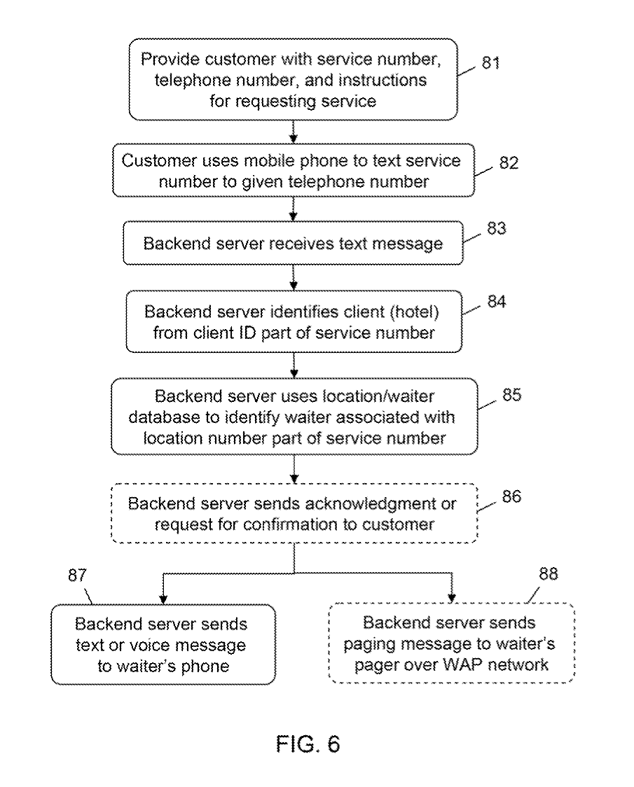

FIG. 6 is a flow chart illustrating the steps of a third exemplary embodiment of the method of the present invention. This embodiment uses text messages such as the Short Messaging Service (SMS) over the PLMN 25 when there is no Wi-Fi network available to the customer. For illustrative purposes, a customer such as a guest at a hotel is presumed to be on the hotel beach away from a restaurant or bar At step 81, the customer is provided with a service number and a telephone number (or short code) and instructions to text the service number to the telephone number (or short code) if the customer needs service. The service number may include a first part representing a client identifier (company, hotel, restaurant, or the like) and a second part representing a location number within the domain of responsibility of the identified company, hotel, or restaurant. For example, a sign on the customer's beach umbrella or chair may state, “If you would like service, please TEXT 349567221 to 54284 .” in this example, the numbers 349567 represent an identifier for the hotel. The numbers 221 represent the particular beach umbrella or chair within that hotel's domain where the customer is seated. The numbers 54284 are an SMS short code.

A short code (or short number) is a dialed number that is shorter than a regular telephone number and is used to address SMS messages. Some short codes are unique to a given operator while others are shared. In some countries, short codes are also shared. If a shared short code is utilized, the customer may be requested to first text a word such as “WAITER” (or similar) to the shared short code. If the customer service is being provided by Operator-A, it can then be determined that Operator-A gets credit for this call. The call may then be routed to the backend server 72. The backend server sends a message back to the customer requesting the customer to enter the service number, which identifies the business establishment and location within that establishment's domain of responsibility. The waiter associated with that location is then notified that the customer needs service. This is explained in more detail below.

At step 82, the customer needs service and uses his cellular phone 71 to text the service number to the given phone number. The message is routed through the PLMN 25 to the backend server 72. At step 83, the backend server receives the text message. At step 84, the backend server uses a client database 70 to identify the client (in this case the customer's hotel) from the client identifier part of the service number (e.g., 349567). At step 85, the backend server uses the location/waiter database 76 to identify a waiter associated with the location number part of the service number (e.g., 221). At step 86, the backend server may optionally send a message back to the customer acknowledging the service request or requesting the customer to confirm that a waiter is needed. At step 87, the backend server may then send a text message or voice message 26 through the PLMN 25 to the identified waiters phone 23 notifying the waiter that the customer at the identified location needs service. At step 88, the backend server may optionally send this notification as a paging message 80 to the identified waiter's wide area pager 90 over the wide area paging network 78.

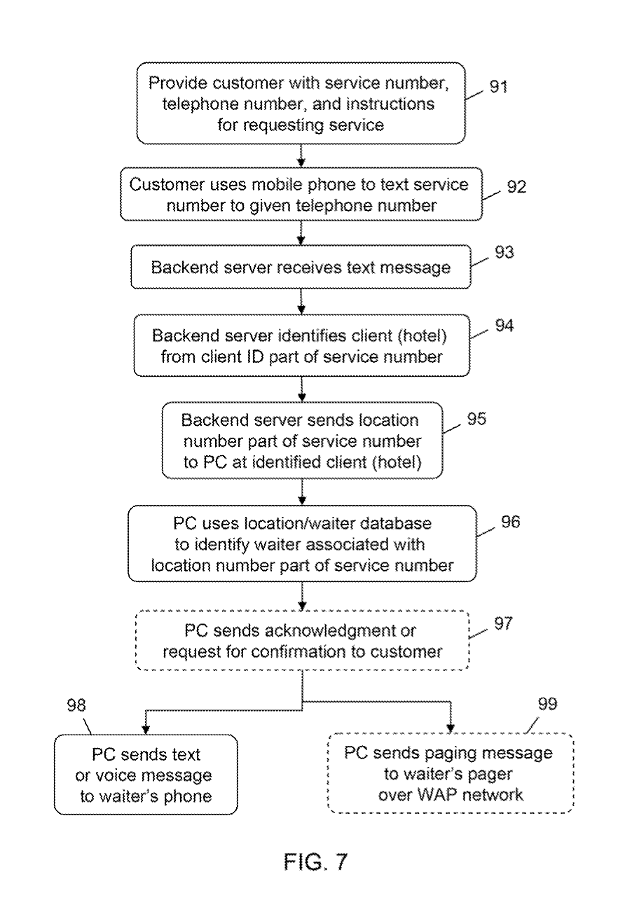

FIG. 7 is a flow chart illustrating the steps of a fourth exemplary embodiment of the method of the present invention. In this alternative embodiment, the database 76 of location numbers and associated service persons is implemented in a PC 79 located at each client's location. The PC also includes a PLMN interface 24 and optionally a wide area paging (WAP) network interface 77.

At step 91, the customer is provided with the service number and the telephone number and instructions to text the service number to the telephone number if the customer needs service. At step 92, the customer needs service and uses his cellular phone 71 to text the service number to the given phone number. The message is routed through the PLMN 25 to the backend server 72. At step 93, the backend server receives the text message. At step 94, the backend server uses the client database 70 to identify the client (in this case the customer's hotel) from the client identifier part of the service number (e.g., 349567). At step 95, based on configurable messaging options set up for the hotel, the backend server may send a message with the location number to the PC 79 at the proper hotel. At step 96, the PC access the location/waiter database 76 to determine the proper waiter/pager number associated with beach umbrella or chair number 221. At step 97, the PC may optionally send a message back to the customer acknowledging the service request or requesting the customer to confirm that a waiter is needed. At step 98, the PC then sends a text or voice message to the waiter with “SERVICE 221”. At step 99, the PC may optionally send this notification as a paging message to the identified waiter's wide area pager over the wide area paging network 78.

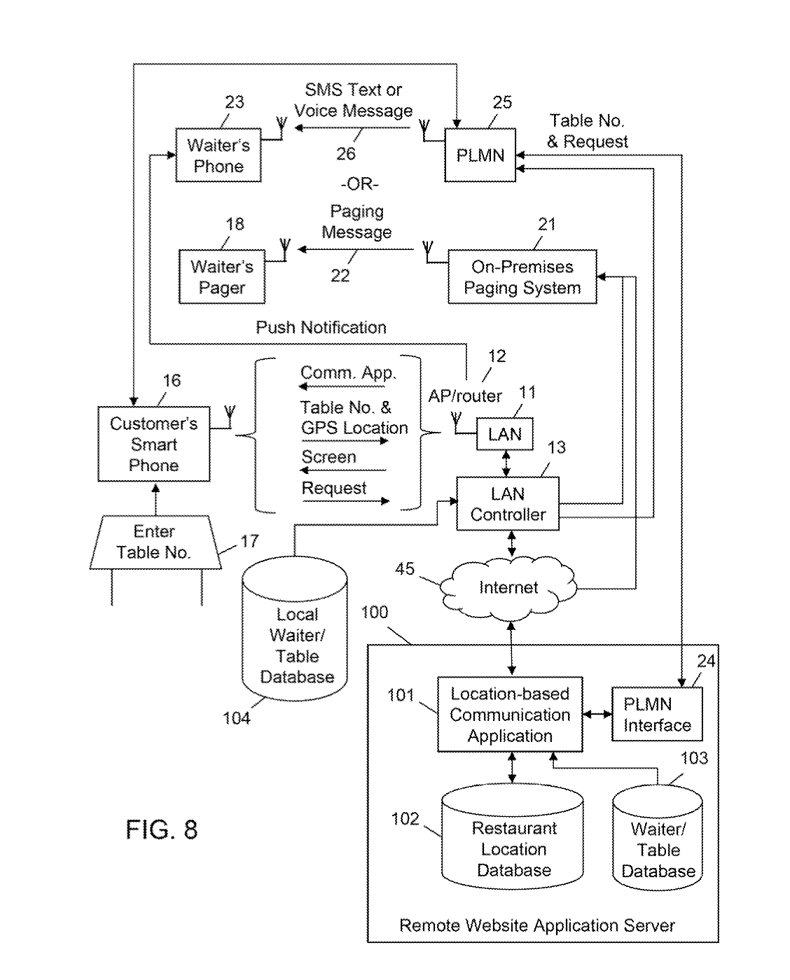

FIG. 8 is a simplified block diagram of a fifth and a sixth exemplary embodiment of the system of the present invention. In the fifth embodiment, the customer uses the smart phone 16 to access a remote Website Application Server (AS) 100 and download a location-based communication application 101. This may be done in advance through the PLMN 24 before arriving at the restaurant, or may be done in one of several ways after arriving. For example, from the restaurant premises, the customer may use the smart phone to join the restaurant's WiFi LAN 11 from which the customer can access the remote Website AS 100 through the Internet 45 to download the location-based communication application. Alternatively, the phone may access the remote Website AS 100 through the PLMN 25 and the Internet 45 to download the location-based communication application. The Website AS may include a restaurant location database 102 and optionally a waiter/table database 103. The Website AS pushes a screen to the customer's smart phone, which displays service buttons defined by the restaurant. When the customer presses a defined button, a request for service is sent to the remote Website AS. The LAN controller 13 periodically checks with the Website AS and sees the request and the table number. The LAN controller then notifies the proper waiter of the request and the table number.

In the sixth embodiment, the customer uses the smart phone 16 to join the restaurant's WiFi LAN 11. The customer is provided with a web page address, and he enters this address on his smart phone. The AP/WiFi router 12 reroutes the request to a local website hosted by the LAN controller 13 utilizing, for example, a Domain Name Server (DNS) table. The LAN controller then pushes a screen to the customer's smart phone, which displays service buttons defined for the assigned waiter. When the customer presses a defined button, the LAN controller then notifies the assigned waiter of the request and the table number.

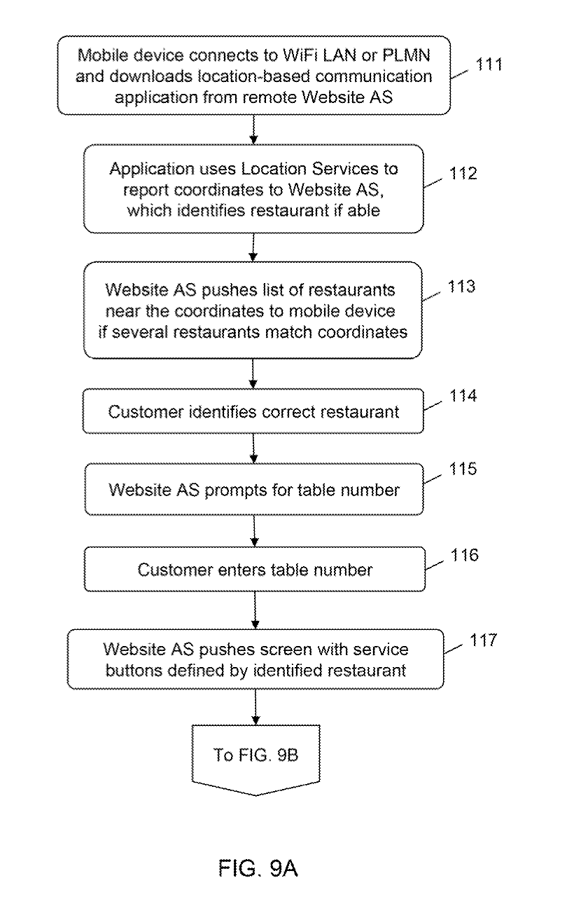

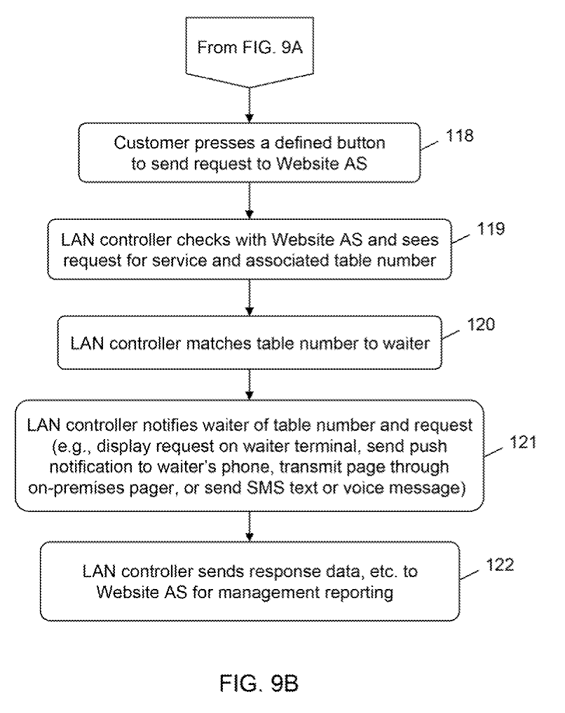

FIGS. 9A-9B are portions of a flow chart illustrating the steps of the fifth exemplary embodiment of the method of the present invention. At step 111, the customer uses the smart phone 16 to connect to the restaurant's WiFi LAN 11 or the PLMN 25 and to download the location-based communication application. The application may require registration or logging in to help prevent abuse of the system and the sending of unauthorized requests for services. At step 112, the application uses Location Services (for example GPRS, WiFi, or GPS) to report the smart phone's location coordinates to the remote Website AS 100 via, for example, GPRS data The location-based communication application 101 accesses the restaurant location database 102 and uses the reported location of the customer's smart phone to identify the restaurant where the customer is located. If unable to identify the restaurant (for example when two or more restaurants are in close proximity), the method moves to step 113 where the application 101 sends a list of nearby restaurants back to the smart phone 16 and asks the customer to identify the restaurant. At step 114, the customer identifies the correct restaurant from the list. At step 115, the Website AS prompts the customer to enter the table number, which may be shown on a card at his table. At step 116, the customer enters the table number, which is sent to the Website AS. At step 117, the Website AS pushes a screen to the smart phone, which displays the identified restaurant's customizable service buttons on the phone. Each restaurant served by the system may define its own layout of service buttons and design for the screen. The method then moves to FIG. 9B.

At step 118, the customer presses a defined button to send a request to the remote Website AS 100. At step 119, the LAN controller 13 periodically checks with the Website AS and sees the request for service and the associated table number. At step 120, the LAN controller utilizes a local waiter/table database 104 to match the table number to the assigned waiter. At step 121, the LAN controller notifies the assigned waiter of the table number and request. The LAN controller may display the request and table number on the screen of a terminal at the assigned waiter's station. Alternatively, if the waiter's phone is logged onto the LAN, the LAN controller may send a push notification 105 to the waiter's phone 23. If the restaurant is equipped with an on-premises paging system 21, the LAN controller may page the assigned waiter's pager 18 through the on-premises paging system. If the LAN controller is equipped with a PLMN interface, the LAN controller may send an SMS text or a recorded voice message to the waiter's phone through the PLMN. At step 122, the LAN controller sends data regarding the request and response to the Website AS for management reporting.

In one embodiment, all restaurant waiter/table assignments are stored in both the waiter/table database 103 in the remote Website AS 100 and the local waiter/table database 104. The system periodically synchronizes the two databases.

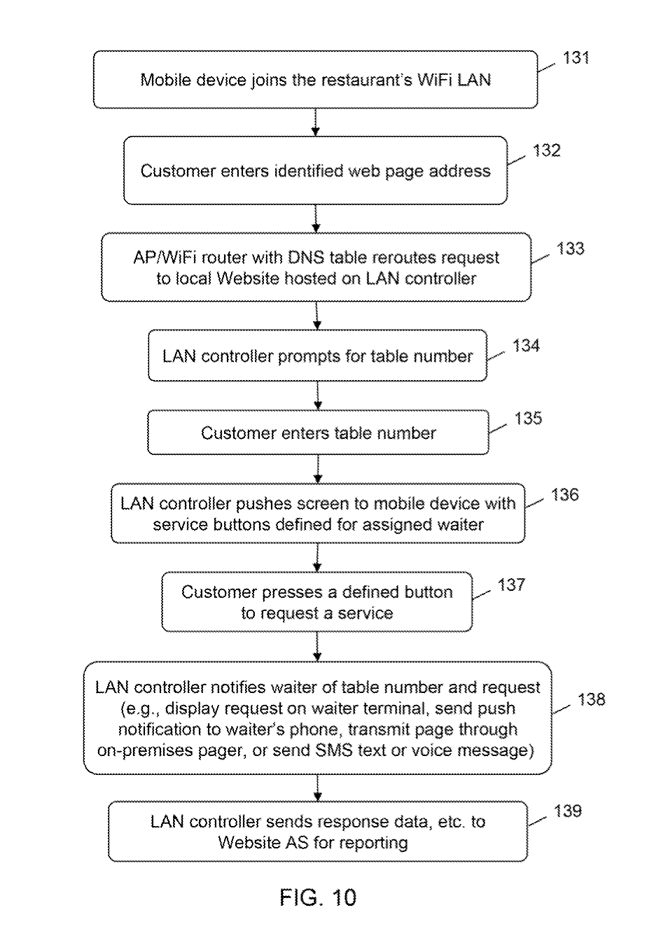

FIG. 10 is a flow chart illustrating the steps of the sixth exemplary embodiment of the method of the present invention. At step 131, the customer uses the smart phone 16 to join the restaurant's WiFi LAN 11 At step 132, the customer may enter an identified web page address, which may be provided, for example, on a sign on the customer's table or by a receptionist. At step 133, the AP/router 12 reroutes the request to a local website hosted on the LAN controller 13. At step 134, the LAN controller prompts the customer to enter the table number, which is entered at step 135. At step 136, the LAN controller pushes a screen with defined service buttons to the customer's smart phone for display. The restaurant may define different buttons and/or a different layout of the buttons for each waiter.

At step 137, the customer presses a defined button to request a service. The LAN controller 13 receives the request and determines the assigned waiter either from the local waiter/table database 104 or by analyzing which button was pressed if the restaurant has defined different buttons for each waiter. At step 138, the LAN controller notifies the assigned waiter of the table number and request. The LAN controller may display the request and table number on the screen of a terminal at the assigned waiter's station. Alternatively, if the waiter's phone is logged onto the LAN, the LAN controller may send a push notification 105 to the waiter's phone 23. If the restaurant is equipped with an on-premises paging system 21, the LAN controller may page the assigned waiter's pager 18 through the on-premises paging system. If the LAN controller is equipped with a PLMN interface, the LAN controller may send an SMS text or a recorded voice message to the waiter's phone through the PLMN. At step 139, the LAN controller sends data regarding the request and response to the Website AS for management reporting.

It is thus believed that the operation and construction of the present invention will be apparent from the foregoing description. While the system and apparatus shown and described has been characterized as being preferred, it will be readily apparent that various changes and modifications could be made therein without departing from the scope of the invention as defined in the following claims.

What is claimed is:

1. A method of enabling a customer to utilize a personal mobile telecomputing device to communicate with a waiter in a restaurant, the method comprising the steps of:
establishing a connection between the customer's mobile telecomputing device and a Website Application Server (AS);
downloading to the customer's mobile telecomputing device, a location-based communication application from the Website AS;
reporting by the application, location information of the customers mobile telecomputing device to the Website AS;
identifying by the Website AS, the restaurant where the customer is located based on the reported location information;
receiving by the Website AS, a table number where the customer is seated in the identified restaurant;
pushing from the VVebsite AS to the customers mobile telecomputing device, a screen displaying buttons for requesting services in the restaurant;
receiving by the Website AS, an indication that the customer pressed one of the buttons associated with a service request; and
routing the service request and table number to a communication device accessible by the assigned waiter.

2. The method according to claim 1, wherein the step of establishing a connection between the customers mobile telecomputing device and the Website AS includes:
establishing a wireless connection between the customer's mobile telecomputing device and a Public Land Mobile Network (PLMN); and
establishing a connection between the PLMN and the Website AS.

3. The method according to claim 1, wherein the step of establishing a connection between the customers mobile telecomputing device and the Website AS includes:
establishing a wireless connection between the customer's mobile telecomputing device and a wireless local area network (LAN) controller within the restaurant; and
establishing a connection between the LAN controller and the Website AS.

4. The method according to claim 3, wherein the step of routing the service request and table number to a communication device accessible by the assigned waiter includes:
sending from the Website AS to the LAN controller within the restaurant, the service request and the table number where the customer is seated;
matching the table number to an assigned waiter by the LAN controller; and
routing the service request and table number by the LAN controller to the communication device accessible by the assigned waiter.

5. The method according to claim 4, wherein the communication device accessible by the assigned waiter is a pager, and the step of routing the service request and table number by the LAN controller includes:
sending the service request and table number from the LAN controller to an on-premises paging system; and
transmitting the service request and table number by the on-premises paging system to the assigned waiter's pager.

6. The method according to claim 1, wherein the communication device accessible by the assigned waiter is a mobile phone, and the step of routing the service request and table number includes sending the service request and table number from the LAN controller to the waiter's mobile phone in a push notification through an access point for the wireless local area network in the restaurant.

7. The method according to claim 1, wherein the step of routing the service request and table number includes sending the service request and table number to a fixed terminal accessible by the waiter.

8. A system for enabling a customer to utilize a personal mobile telecomputing device to communicate with a waiter in a restaurant, the system comprising:
at least one processor for controlling operation of the system;
a Website Application Server (AS); and
a wireless local area network (LAN) within the restaurant for communicating with the customer's mobile telecomputing device, the LAN including a LAN controller configured to download to the customer's mobile telecomputing device, a location-based communication application, which causes the customer's mobile telecomputing device to report location information of the customer's mobile telecomputing device to the Website AS;
wherein the Website AS is configured to;
identify the restaurant where the customer is located based on the reported location information;
receive a table number where the customer is seated in the identified restaurant;
push to the customer's mobile telecomputing device, a screen displaying buttons for requesting services in the restaurant;
receive an indication that the customer pressed one of the buttons associated with a service request; and
communicate to the LAN controller within the restaurant, the service request and the table number where the customer is seated;
wherein the LAN controller is further configured to:
match the table number to an assigned waiter; and
route the service request and table number to a communication device accessible by the assigned waiter.

9. The system according to claim 8, wherein the communication device accessible by the assigned waiter is a pager, and the LAN controller is configured to send the service request and table number to an on-premises paging system for transmission to the assigned waiters pager.

10. The system according to claim 8, wherein the communication device accessible by the assigned waiter is a mobile phone, and the LAN controller is configured to send the service request and table number to the waiter's mobile phone in a push notification through an access point for the wireless local area network in the restaurant.

11. The system according to claim 8, wherein the communication device accessible by the assigned waiter is a fixed terminal accessible by the waiter, and the LAN controller is configured to send the service request and table number to the fixed terminal.

12. A method of enabling a customer to utilize a personal mobile telecomputing device to communicate with a waiter in a restaurant, the method comprising the steps of:
connecting the customer's mobile telecomputing device to a wireless local area network (LAN) controlled by a LAN controller within the restaurant;
receiving by an Access Point for the LAN from the customer's mobile computing device, a request to navigate to a web page address;
routing the request by the Access Point to a local web page hosted by the LAN controller;
obtaining by the LAN controller from the customer's mobile telecomputing device, a table number where the customer is seated in the restaurant;
pushing by the LAN controller to the customers mobile telecomputing device, a screen displaying buttons for requesting services in the restaurant;
receiving by the LAN controller, an indication that the customer pressed one of the buttons associated with a service request;
determining by the LAN controller, an assigned waiter for the customer; and
routing the service request and table number by the LAN controller to a communication device accessible by the assigned waiter.

13. The method according to claim 12, wherein the communication device accessible by the assigned waiter is a pager, and the step of routing the service request and table number includes:
sending the service request and table number from the LAN controller to an on-premises paging system; and
transmitting the service request and table number by the on-premises paging system to the assigned waiter's pager.

14. The method according to claim 12, wherein the communication device accessible by the assigned waiter is a mobile phone, and the step of routing the service request and table number includes sending the service request and table number from the LAN controller to the waiter's mobile phone in a push notification through the Access Point.

15. The method according to claim 12, wherein the step of routing the service request and table number includes sending the service request and table number to a fixed terminal accessible by the waiter.

16. A system for enabling a customer to utilize a personal mobile telecomputing device to communicate with a waiter in a restaurant, the system comprising:
at least one processor for controlling operation of the system;
a wireless local area network (LAN) within the restaurant for communicating with the mobile telecomputing device, the LAN including an Access Point and a LAN controller;
wherein the Access Point is configured to:
receive from the customers mobile computing device, a request to navigate to a web page address; and
route the request to a local web page hosted by the LAN controller;
wherein the LAN controller is configured to:
obtain from the customer's mobile telecomputing device, a table number where the customer is seated in the restaurant;
push to the customer's mobile telecomputing device, a screen displaying buttons for requesting services in the restaurant;
receive an indication that the customer pressed one of the buttons associated with a service request;
determine an assigned waiter for the customer; and
route the service request and table number to a communication device accessible by the assigned waiter.

17. The system according to claim 16, wherein the communication device accessible by the assigned waiter is a pager, and the LAN controller is configured to send the service request and table number to an on-premises paging system for transmission to the assigned waiter's pager.

18. The system according to claim 16, wherein the communication device accessible by the assigned waiter is a mobile phone, and the LAN controller is configured to send the service request and table number to the waiter's mobile phone in a push notification through the Access Point.

19. The system according to claim 16, wherein the communication device accessible by the assigned waiter is a fixed terminal accessible by the waiter, and the LAN controller is configured to send the service request and table number to the fixed terminal.
